(19) United States
(12) Patent Application Publication
(10) Pub. No.: US 2002/0102966 A1
(43) Pub. Date: Aug. 1, 2002

(54) Object identification method for portable devices

(76) Inventors: Tsvi H. Lev, Tel Aviv (IL); Ofer Bar-Or, Givatayim (IL)

Correspondence Address: SUGHRUE MION, PLLC, 2100 Pennsylvania Avenue, NW, Washington, DC, 20037-3213, US

(21) Appl. No.: 09/985,849

(22) Filed: Nov. 6, 2001

Related U.S. Application Data
(60) Provisional application No. 60/245,661, filed on Nov. 6, 2000.

(51) Int. Cl. H04B 1/38

(52) U.S. Cl. 455/412; 455/556; 709/217

(57) ABSTRACT

An object identification method for wireless portable devices for a user equipped with a portable wireless imaging device to be able to obtain information and services related to imaged objects, where the object identification is performed at least partially by a remote computational facility, and where the object identification is based on acquired images of the object. The method includes an imaging device, capable of taking one-dimensional or two dimensional images of objects; a device capable of sending the coded image through a wireless channel to remote facilities; algorithms and software for processing and analyzing the images and for extracting from them symbolic information such as digits, letters, text, symbols or icons; algorithms and software facilitating the identification of the imaged objects based on the information gathered from the image and the information available in databases; and algorithms and software for offering various information or services to the user of the imaging device based on the information gathered from the image and the information available in databases.

The present application is based on Serial No. 60/245,661 filed on Nov. 6, 2000, the contents of which are hereby incorporated by reference.

### BACKGROUND OF THE INVENTION

1. Field of the Invention

The present invention relates generally to wireless imaging technology and more specifically it relates to an object identification method for wireless portable devices for a user equipped with a portable wireless imaging device to be able to obtain information and services related to imaged objects, where the object identification is performed at least partially by a remote computational facility, and where the object identification is based on an acquired image or images of the said object. The imaging device and the wireless device can be one entity, as in a cellular phone or PDA with an integrated camera, or they can be two separate devices, as in a digital camera connected by wire or wirelessly to a cellular phone or other wireless transmission device.

2. Description of the Related Art

It can be appreciated that object or printed material identification technology has been in use for years. Typically, an object identification system is comprised of:

1. An OCR, watermark or barcode analysis software running on a PC, Workstation or a dedicated processing engine.

2. Portable devices equipped with an imaging device and computational engine for performing OCR, barcode or watermark analysis on the scanned/acquired images. The main problem with conventional devices for image based object identification is that for high quality identification powerful software is required. This software utilizes high-end processors and large quantities of memory, and hence typically runs on a non-portable device such as a personal computer. As an example for such a system is the watermark identification system called MediaBridge™ developed by Digimarc Inc, where the processing is done on a PC.

In a special purpose portable and/or wireless device, the computation capacity is much lower, and hence the recognition task is simplified by using higher quality, special purpose image acquisition and/or by decoding simpler codes. Examples for these tradeoffs and their solutions include:

1. Standard barcodes, sampled by a bar-code reader, featuring a dedicated illuminator and/or detector optimized for the task of linear bar-code decoding. Pertinent examples include the barcode readers made by ConnectThings, DigitalConvergence, Gamut-interactive etc. These devices cannot decode anything by a standard barcode.

2. For performing reliable OCR using limited performance software, one may incorporate into the system a high quality, special purpose linear scanner such as the one used in the Quicktionary™ product by WizCom. With a special purpose scanner the OCR task becomes simpler.

3. One can limit the OCR functionality to a very limited set of alpha-numeric characters in a limited set of fonts. Hence the processing and memory requirements are reduced, making the implementation portable. The Quicktionary™ and Cpen™ devices are examples.

Another problem with conventional devices for image based object identification is that the portable devices perform lower grade recognition (such as OCR) because of power, size and price constraints, and hence give the user a limited capacity in terms of handling difficult imaging conditions, low grade print or handwriting, special fonts and different languages. Portable devices are also harder to upgrade when new versions of software become available.

Another problem with conventional devices for image based object identification is that the portable devices are special purpose and hence have to be purchased and carried separately to provide only this function. Furthermore, many of these devices are not connected on-line to the Internet or other on-line data bases, and hence cannot provide real-time or semi-real-time connection to data based on the scanned image, text or symbols.

It should be mentioned that devices for sending wireless images are now becoming commonplace. Some examples are:

1. The Nokia 9110 Cellular phone is capable of interfacing using an IrDA port to a digital camera and sending the image.

2. Lightsurf Inc. has a system for a special purpose camera attached to a cellular phone.

3. ActivePhoto Inc. is making devices and software for attaching numerous digital cameras to cellular phones.

1. Cpen is making a device for scanning text/images and sending it to a cellular phone by the BlueTooth™ wireless protocol.

5. Ericsson is working with Cannon to make a cellular phone and camera system.

While these devices may be suitable for the particular purpose to which they address, they are not as suitable for a user equipped with a portable wireless imaging device to be able to obtain information and services related to imaged objects, where the object identification is performed at least partially by a remote computational facility, and where the object identification is based on acquired images of the object.

In these respects, the object identification method for wireless portable devices according to the present invention substantially departs from the conventional concepts and designs of the prior art, and in so doing provides an apparatus primarily developed for the purpose of a user equipped with a portable wireless imaging device to be able to obtain information and services related to imaged objects, where the object identification is performed at least partially by a remote computational facility, and where the object identification is based on acquired images of the object.

Some relevant patents that represent the prior art are:

1. In the field of algorithms and image processing operations for removing the effects of imaging under uncontrolled illumination and with low quality/limited imaging devices, there are numerous patents, see e.g. U.S. Pat. No. 5,771,312, incorporated herein by reference. The implementation of such existing algorithms and methods in the remote server for improving the image quality for human observers are also not new. The concept of developing and optimizing such algorithms as part of a remote server for improving the accuracy of the object identification is new.

2. Many algorithms exist for performing printed and hand-typed character recognition based on images, see e.g. U.S. Pat. Nos. 5,359,671, 6,011,879, 4,977,602, 5,542,006, each of these four patents is incorporated herein by reference. In the method according to the invention, one inventive aspect lies in utilizing such algorithms for performing object identification rather than e.g. performing word identification as part of inputting a printed page into a computer as text.

3. There is also significant prior art on using special marks or codes such as barcodes, watermarks etc for object identification, see e.g. U.S. Pat. Nos. 5,978,733, 5,933,829, each of these two U.S. patents is incorporated by reference. On the other hand, the inventive method uses standard marks such as numerals or text that appeared on the object for human reading, and emulating the human method of object identification. The limitation of using special marks is that access to the full world of objects that were not marked specifically for automated identification is not available. For example, in the case of scanning barcodes, the inventive method does not require a dedicated barcode scanner but rather it uses a standard imaging device, and it interprets the data contained in the barcode based on both the lines and the digits rather than based solely on the lines.

### SUMMARY OF THE INVENTION

In view of the foregoing disadvantages inherent in the known types of object identification technology now present in the prior art, the present invention provides a new object identification method for wireless portable devices construction wherein the same can be utilized for a user equipped with a portable wireless imaging device to be able to obtain information and services related to imaged objects, where the object identification is performed at least partially by a remote computational facility, and where the object identification is based on acquired images of the object, and potentially on other additional information, such as (but not limited to) the device/user location, user profile, previous user actions, and the user's textual, manual or acoustic inputs.

The general purpose of the present invention, which will be described subsequently in greater detail, is to provide a new object identification method for wireless portable devices that has many of the advantages of the object identification technologies heretofore and many novel features that result in a new object identification method for wireless portable devices which is not anticipated, rendered obvious, suggested, or even implied by any of the prior art of wireless imaging technology, either alone or in any combination thereof.

To attain this, the present invention generally comprises:

1. An imaging device, capable of taking one-dimensional or two-dimensional images of objects.

2. A device capable of sending the coded image through a wireless channel to remote facilities.

3. Algorithms and software for processing and analyzing the images and for extracting from them symbolic information such as digits, letters, text, symbols or icons

4. Algorithms and software facilitating the identification of the imaged objects based on the information gathered from the image and the information available in databases.

5. Algorithms and software for offering various information or services to the user of the imaging device based on the information gathered from the image and the information available in databases.

The imaging device is a unit capable of acquiring images, storing and/or sending them. The wireless device is capable of sending images to remote facilities. The algorithms perform compression artifact correction, noise reduction, color corrections, geometric corrections, imager non-uniformity correction, etc., and various image processing enhancement operations to better facilitate the operation of the next stage of image understanding algorithms. The algorithms are implemented as a plurality of software objects residing on one or more computational devices. Algorithms performing, among other operations, digit recognition, printed and handwritten text recognition, symbol, logo and watermark recognition, and general texture and shape recognition. The algorithms are implemented as a plurality of software objects residing on one or more computational devices. Also included is software for utilizing the information extracted in the previous computation stages for data storage, extraction and/or communication with a plurality of internal and/or external applications, such as databases, search engines, price comparison sites etc. Also included is software for sending relevant information and/or services back to the user by any means.

The invention may include, in certain embodiments, algorithms for determining where and by which computational device the processing will be carried, based on parameters such as device loads, capabilities, network conditions, security constraints, etc.

The invention may include, in certain embodiments, algorithms for determining that the automatic object recognition has failed or that the results are suspect, or that the user desires human intervention, or that the user has specified that he wants human recognition to be applied, and direct the visual or other information gathered to a system where human beings may perform the recognition task or utilize partially automatic algorithms to accomplish the same goal.

The invention may also include, in certain embodiments, software for assisting, instructing and informing the user through, for example a graphical user interface, of the various stages of operation such as proper image capture, alignment, wireless link availability etc.

There has thus been outlined the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an object identification method for wireless portable devices that will overcome the shortcomings of the known devices.

An object of the present invention is to provide an object identification method for wireless portable devices for a user equipped with a portable wireless imaging device to be able to obtain information and services related to imaged objects, where the object identification is performed at least partially by a remote computational facility, and where the object identification is based on acquired images of the said object.

Another object is to provide an object identification method for wireless portable devices that utilizes a cellular phone, personal digital assistant or other device equipped with an imaging device and with connectivity to other computational sources such as the internet, to provide advanced image recognition and understanding services using remote computational facilities for performing OCR, barcode and logo analysis.

Another object is to provide an object identification method for wireless portable devices that performs image pre-processing to correct for image artifacts created by the imaging conditions which apply to imaging a substantially planar surface (such as a sheet of printer paper, a product label, a sticker etc.) in various uncontrolled illumination conditions such as those found in normal day to day environments, where the imaging device is a camera or linear scanner.

Another object is to provide an object identification method for wireless portable devices that performs image pre-processing to correct for image artifacts generated by the imaging optics, electronics, compression and/or communication error correction schemes for one of the above mentioned devices.

Another object is to provide an object identification method for wireless portable devices that performs image enhancement using multiple still images or image sequences or video sequences to improve the image quality for one of the above mentioned devices.

Another object is to provide an object identification method for wireless portable devices that utilizes computational models involving a remote computational facility (“server”) and distributed processing in this facility to provide faster response times.

Another object is to provide an object identification method for wireless portable devices that utilizes the information extracted from the image to detect the imaged object, and using this information connects the user with information, web sites or telephone numbers related to this object.

Another object is to provide an object identification method for wireless portable devices that utilizes the information extracted from the image to store, send or manipulate a description on this object in a non-image format, e.g. a text string, a digit string, or a code.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

FIG. 1 is an exploded view showing the various components of an embodiment of the invention;

FIG. 2 is a processing flow chart according to an embodiment of the invention;

FIG. 3 is a processing flow chart according to an embodiment of the invention;

FIG. 4 is a data flow chart according to an embodiment of the invention.

### DETAILED DESCRIPTION OF THE PREFERRED BODIMENT

Various other objects, features and attendant advantages of the present invention will become fully appreciated as the same becomes better understood when considered in conjunction with the accompanying drawings, in which like reference characters designate the same or similar parts throughout the several views.

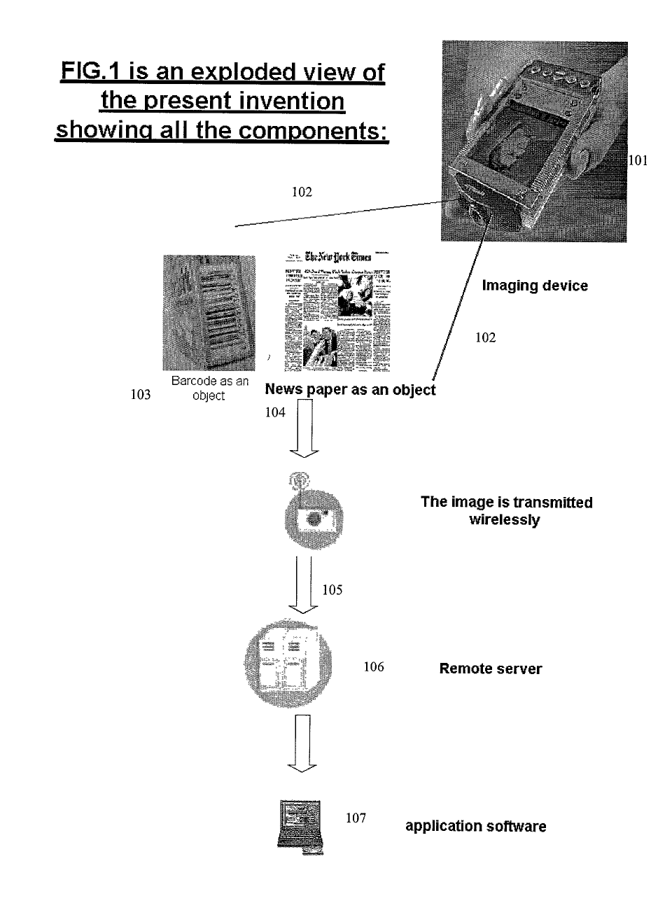

FIG. 1 is an exploded view of an embodiment of the present invention showing all the system components.

Item 101 is the imaging device, as described previously. In terms of novel additions, the imaging device may contain image compression algorithms specially optimized for the task of image compression for optimal identification rather than optimal appearance. For example, for the identification of printed text/numerals. The system can convert the image into a binary black and white image for better compression, even though it makes the image less visually appealing. Potentially, the device may run specific software—e.g. code written In J2ME, to optimize the image taking operation.

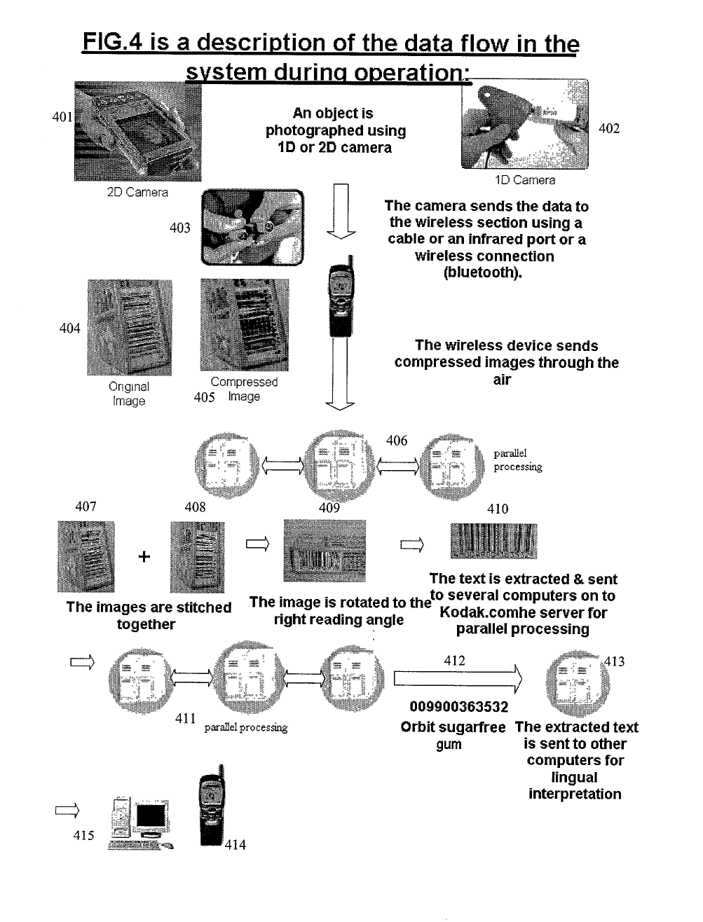

In item 102 the imaging operation is performed through the camera Field Of View (FOV). Part of the novelty of the invention lies in the understanding that through the remote server one can stitch several images to form the complete image required for identifying the object (see also FIG. 4).

Item 103 represents a potential identifying mark, such as a barcode. One aspect of the novel method is that the barcode is not read using a specially designed device but rather using a general purpose imaging device.

Item 104 represents another potential identifying mark, such as the printed text in a document. In the case of e.g. a newspaper, the headings or even just fragments of text in a story/advertisement could serve as identifying information.

In item 105, once the image or set of images is acquired it is transmitted through any wireless/wireline combination of data transmission paths to the remote server. The remote server could be far apart e.g. in the central office of a wireless cellular operator, or it could be a few meters away from the imaging device and connected to it by a WLAN such as Bluetooth.

Item 106 is the remote server, which then proceeds to apply the described sequence of algorithms, which can be a combination of known and novel algorithms. Appendix A provides a detailed description of the algorithms for barcode detection and decoding. The processing server applies such sequences of algorithms that result in the identification of the imaged object.

Item 107 is the remote server itself (or a different remote server connected to it). Server 107 can, based on the object identification information, extract information about the object from databases/public data networks such as the internet. For example, the ISBN number of a book could be used to perform an HTTP GET request to a web site such as Amazon in order to retrieve the product's price, reviews about it etc.

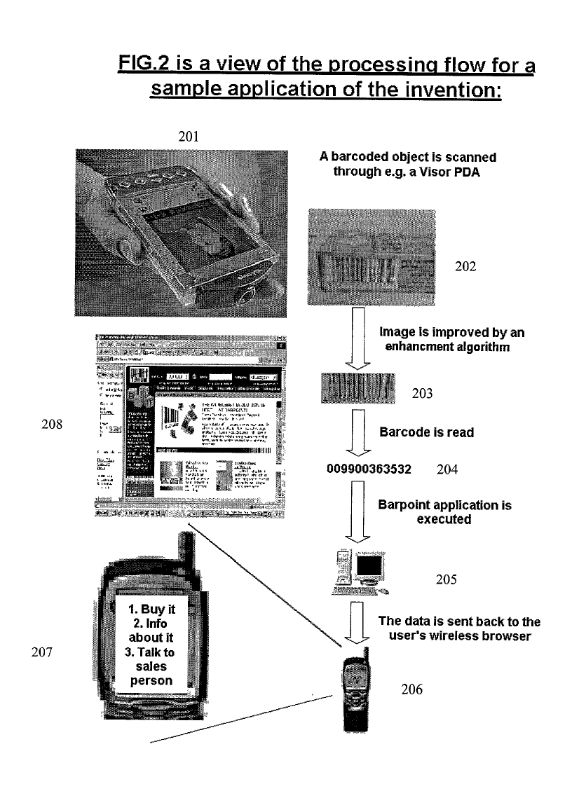

FIG. 2 is a view of the processing flow for a sample application of the invention.

Item 201 is the imaging device (as described as item 101 in FIG. 1).

Item 202 is the image of a standard UPC barcode on a commercial product.

Item 203 is the part of the image that has been extracted by either the imaging device or by the remote server and contains the information necessary for object identification. The algorithms required to implement this stage are described in Appendix A.

Item 204 is the string of identifying numbers that has been extracted using algorithms such as those described in Appendix A.

Item 205 is the server, which then formulates e.g. an HTTP request or a database SQL query to retrieve more information about the product—e.g. price, availability, qualities, rating, limitations on sale etc.

Item 206 is the target device. The retrieved information is then reformatted for display on the screen of the target device—so for example graphics may be taken out or reduced in color depth or size before they are sent to the device 206, and the binary format in which they are packaged has to be adapted to the recipient device. This can be done by the remote server or by a different entity.

In item 207 the server's response may include menu options and perform activities on the display device, so the product can be bought or inquired about.

Item 208 shows that the same information (or more information) can also be sent aft to other display devices such as the user's personal computer, e-mail account etc. This can enable richer interaction at a later time when the user is near a more powerful device. The content is adapted in any case to the different target devices.

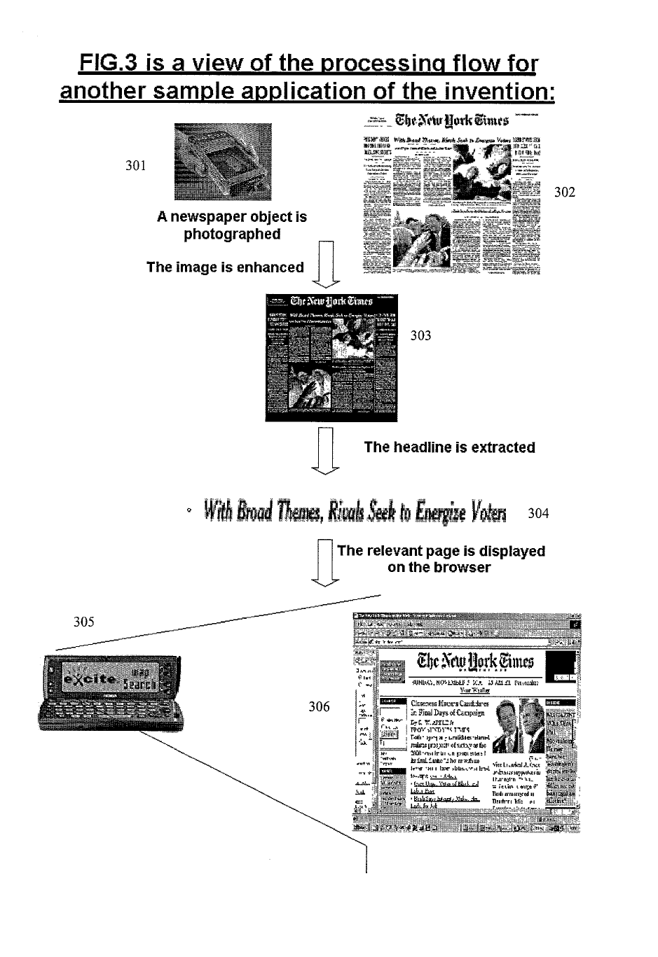

FIG. 3 is a view of the processing flow for another sample application of the invention.

Item 301 is the imaging device (as described as item 101 in FIG. 1).

Item 302 is the image of a part of a newspaper page.

Item 303 is the image after image processing operations have been performed on it to decrease the file size and/or improve the object identification's chances. In this example the image is binarized after some local histogram equalization operations.

In item 304, the OCR engine running on the remote server identifies the part of the image containing legible text and extracts the maximum number of characters and their relative geometrical position. This information is then used, in conjunction with a database of the newspaper itself, to identify the relevant story/segment. It should be noted that for identification purposes even a very partial success in the character recognition task should be sufficient. In item 305, again the results are reformatted and transcoded optimally to the target device—which is not necessarily the original imaging device 301.

FIG. 4 is a description of the data flow in the system according to one embodiment of the invention.

Item 401 is the imaging device (as described as item 101 in FIG. 1).

Item 402 is another potential imaging device with a line scanner rather than a two dimensional imager.

Item 403 is the data transmission apparatus in cases where the image acquisition part of the device is connected to the data transmission apparatus through a cable or some special wireless connection.

Item 404 is the original acquired image prior to any manipulation.

Item 405 is the compressed image prior to sending, where the image compression parameters and algorithm may have been optimized for object identification purposes rather than for visual appeal.

Item 406 is the remote server system, which may be comprised of a series of servers where the image processing operations between these servers are distributed (either on a per image basis or on a per-request basis) for optimizing the computational resources and/or the total response time. The distribution may be performed via commercial load balancing equipment or by proprietary load balancing software.

Items 407 and 408 are two separate images that have been acquired and can be stitched together in the remote server to form one complete image.

Item 409 the image is then rotated to the right angle for OCR detection (see Appendix A for a detailed discussion of this operation), where the algorithm measures the image angle using the line pattern of the barcode.

In item 410, the part of the image containing numerals is extracted using a special algorithm (see Appendix A).

In item 411, OCR operations then take place on the remote server, where again parallel processing may take place to enable testing many more image parameter configurations or OCR fonts, or several different OCR engines may be run in parallel and the final result determined by some form of voting mechanism.

In item 412, the string of the decoded numbers (which may contain some errors) is sent for interpretation to better decide e.g. the type of the barcode (UPC,EAN, some proprietary format etc.). Some error correction algorithms may be used at this stage to utilize the inherent redundancy in the digits to correct for identification errors. Finally, in item 413, the extracted text is sent to other computer lingual interpretation.

Based on the above figures, the object identification method for wireless portable devices includes the following operations:

1. An imaging device, capable of taking one-dimensional or two-dimensional images of objects.

2. A device capable of sending the coded image through a wireless channel to remote facilities.

3. Algorithms and software for processing and analyzing the images and for extracting from them symbolic information such as digits, letters, text, symbols or icons.

4. Algorithms and software facilitating the identification of the imaged objects based on the information gathered from the image and the information available in databases.

5. Algorithms and software for offering various information or services to the user of the imaging device based on the information gathered from the image and the information available in databases.

The imaging device 101 is a unit capable of acquiring images, storing and/or sending them. The wireless device is capable of sending images to remote facilities. The algorithms perform compression artifact correction, noise reduction, color corrections, geometric corrections, imager non-uniformity correction, etc., and various image processing enhancement operations to better facilitate the operation of the next stage of image understanding algorithms. The algorithms are implemented as a plurality of software objects residing on one or more computational devices. Also included are algorithms performing, among other operations, digit recognition, printed and handwritten text recognition, symbol, logo and watermark recognition, and general shape recognition. The algorithms are implemented as a plurality of software objects residing on one or more computational devices, possibly including the imaging device and/or the wireless device. Software for utilizing the information extracted in the previous computation stages for data storage, extraction and/or communication with a plurality of internal and/or external applications, such as databases, search engines, price comparison sites etc.

The imaging device 101 is a unit capable of acquiring images, storing and/or sending them. The imaging device is a device capable of capturing single or multiple images or video streams and converting them to digital information. It is equipped with the proper optical and electro-optical imaging components and with computational and data storage components. The imaging device can be a digital camera, a PDA with an internal or external camera, a cellular phone with an internal or external camera, or a portable computational device (e.g. laptop, palmtop or Webpad™-like device) with an internal or external camera.

The wireless device is capable of sending images to remote facilities. The wireless device is a device capable of transferring information wirelessly to remote or nearby locations. It is capable of getting the information from the imaging device for processing and transmission. It can also be capable of receiving information wirelessly or using a wired connection. It can also be capable of performing some processing operations reducing the load of sending the raw image to the remote server or even of reducing the computational load on the server by performing other image processing and image analysis operations. The wireless device can be a cellular phone, a wireless PDA, a Webpad™-like device communicating on a local wireless area network, a device communicating using infrared or acoustic energy, etc.

The algorithms perform compression artifact correction, noise reduction, color corrections, geometric corrections, imager non-uniformity correction, etc., and various image processing enhancement operations to better facilitate the operation of the next stage of image understanding algorithms. The algorithms are implemented as a plurality of software objects residing on one or more computational devices. The image processing algorithms are numerical and symbolic algorithms for the manipulation of images and video streams. The algorithms perform compression artifact correction, noise reduction, color corrections, geometric corrections, imager non-uniformity correction, etc., and various image processing enhancement operations to better facilitate the operation of the next stage of image understanding algorithms. The algorithms are implemented as a plurality of software objects residing on one or more computational devices. The algorithms can be implemented as software running on a general purpose processor, DSP processor, special purpose ASIC and/or FPGA's. They can be a mixture of custom developed algorithms and libraries provided by other developers or companies. They can be arranged in any logical sequence, with potential changes in the sequence of processing or parameters governing the processing determined by image type, computational requirements or outputs from other algorithms.

Another aspect of the invention is a collection of algorithms performing, among other operations, digit recognition, printed and handwritten text recognition, symbol, logo and watermark recognition, and general shape recognition. The algorithms are implemented as a plurality of software objects residing on one or more computational devices. The image processing algorithms are numerical and symbolic algorithms for the manipulation of images and video streams. The algorithms perform, among other operations, digit recognition, printed and handwritten text recognition, symbol, logo and watermark recognition, and general shape recognition. The algorithms are implemented as a plurality of software objects residing on one or more computational devices. The algorithms can be implemented as software running on a general purpose processor, DSP processor, special purpose ASIC and/or FPGA's. They can be a mixture of custom developed algorithms and libraries provided by other developers or companies. They can be arranged in any logical sequence, with potential changes in the sequence of processing or parameters governing the processing determined by image type, computational requirements or outputs from other algorithms. The algorithms may reside on a different system belonging to a different entity than the image processing algorithms or the application software.

Another aspect of the invention is software for utilizing the information extracted in the previous computation stages for data storage, extraction and/or communication with a plurality of internal and/or external applications, such as databases, search engines, price comparison sites etc. The application software provides the overall functionality of the service, based on the information extracted in the previous algorithmic stages. It is software for data storage, extraction and/or communication with a plurality of internal and/or external applications, such as databases, search engines, price comparison sites etc. The application software can be implemented as code running on a general purpose processor, DSP processor, special purpose ASIC and/or FPGA's. It can be a mixture of custom developed software and libraries provided by other developers or companies. This software may reside on a different system belonging to a different entity than the rest of the system.

The imaging device captures one or more images or video sequences, which are (potentially) processed on this device and then transferred to the wireless device or the wireless transmission section of the complete device. The data is then transmitted and transferred through some kind of data network or networks to servers which process the information using the above-described algorithms, and then uses the extracted information for various applications. The servers (or other connected entities) may then send information back through the network to the wireless device, or to other devices such as a personal computer or set-top box. A large portion of the processing algorithms may be reside on the portable device, and there may be a dynamically changing division of the algorithms running on the different parts of the system based on relative computational loads and desired user response times, changing imaging and wireless bandwidth conditions. The application software executing for a given image or image sequence may be determined based on the image content itself, rather than being fixed. The application software to be used may be chosen by the user based on pre-configured parameters or during the operation. The outputs of the application software may be sent back to the user through any channel.

The principle of operation is that using images or image sequences or video sequences, a computer can decode the identity of the imaged object, for example a labeled product, a printed form, a page from a book or newspaper, a bill, a membership card, a receipt, a business card, a medical prescription etc. This saves the user the time and effort of inputting the object identity and/or unique information pertaining to the object such as values in numerical fields, addresses in a business card, etc. The imaging device captures images or video sequences, which are (potentially) processed on this device and then transferred to the wireless device or the wireless transmission section of the complete device. The data is then transmitted and transferred through a data network or networks to servers which process the information using the above-described algorithms, and then uses the extracted information for various applications. The servers (or other connected entities) may then send information back through the network to the wireless device, or to other devices such as a personal computer or set-top box.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### Appendix A: Algorithms for Barcode Detection and Extraction

This is a description of the algorithms relevant for utilization of an image of a barcode on the object in order to identify the object by its barcode number.

The algorithm consists of 6 main steps (that will be described in details in the following paragraph):

1) Identify the barcode in the image, by recognizing regions in the image which resemble barcodes (uniformity in one axis and change in the other, etc.) regardless of the image rotation, the tilt of the image plane to the camera and the scale (to a reasonable extent).

2) Based on the above identification, recognize the dimensions, orientation and location of the barcode.

3) Extract a normalized image strip of the digits accompanying the barcode—this strip is now of constant size and is not skewed.

4) Read the digits in the extracted strip, achieving improved quality by utilizing the barcode specific information: relative location of digits, fonts, barcode checksum.

5) Combining the OCR results with a direct optical reading of the barcode's lines, using super-resolution, will further enhance accuracy of reading.

6) Invoking an application specific operation, based on the identified product id (e.g. presenting the web page for this product).

[image]

[image]

[image]

[image]

[image]

[image]

[image]

[image]

[image]

[image]

[image]

[image]

1. A system for acquiring basic information about a particular object of interest, for transmitting and receiving said basic electronic information, for identifying the object from said basic electronic information, for transmitting and receiving additional information or services, and for displaying said additional information, said system comprising:
(a) an imaging device for acquiring said basic information about the object;
(b) a communication device for transmitting the basic information to a remote server and receiving additional information about the object;
(c) a remote server for receiving said basic information about the object, for processing said basic information to identify the particular object of interest, to acquire additional information about the object of interest, and for transmitting said additional information to said communication device;
(d) application software that allows the remote server to identify the object of interest; and
(e) application software that allows the remote server to acquire additional information about said object.

2. The system set forth in claim 1 further comprising a wireline communication link between the communication device and the remote server.

3. The system set forth in claim 1, wherein the additional information is services.

4. The system set forth in claim 1 wherein the imaging device is separate from the communication device in element b, but these two devices are linked electronically.

5. The system set forth in claim 1 wherein the imaging device and the communication device are comprised of only one device that performs both imaging and communication.

6. The system set forth in claim 2 wherein the communication device is a PDA.

7. The system set forth in claim 3 wherein the communication device is a PDA.

8. The system set forth in claim 4 wherein the imaging device is a PDA.

9. The system set forth in claim 5 wherein the single device for imaging and communication is a PDA.

10. The system set forth in claim 3 wherein the communication device that performs the communication link with the remote server is a cellular telephone.

11. The system set forth in claim 4 wherein the communication device is a cellular telephone.

12. The system set forth in claim 5 wherein the single device for imaging and communication is a cellular telephone.

13. The system set forth in claim 1 wherein the basic information includes at least one piece of information from the group consisting of the device/user location, the user profile, previous user actions, the user's textual inputs, the user's manual inputs, and the user's acoustic inputs.

14. The system set forth in claim 2 wherein the basic information includes at least one piece of information from the group consisting of the device/user location, the user profile, previous user actions, the user's textual inputs, the user's manual inputs, and the user's acoustic inputs.

15. The system set forth in claim 3 wherein the basic information includes at least one piece of information from the group consisting of the device/user location, the user profile, previous user actions, the user's textual inputs, the user's manual inputs, and the user's acoustic inputs.

16. The system set forth in claim 4 wherein the basic information includes at least one piece of information from the group consisting of the device/user location, the user profile, previous user actions, the user's textual inputs, the user's manual inputs, and the user's acoustic inputs.

17. The system set forth in claim 5 wherein the basic information includes at least one piece of information from the group consisting of the device/user location, the user profile, previous user actions, the user's textual inputs, the user's manual inputs, and the user's acoustic inputs.

18. The system set forth in claim 6 wherein the basic information includes at least one piece of information from the group consisting of the device/user location, the user profile, previous user actions, the user's textual inputs, the user's manual inputs, and the user's acoustic inputs.

19. The system set forth in claim 7 wherein the basic information includes at least one piece of information from the group consisting of the device/user location, the user profile, previous user actions, the user's textual inputs, the user's manual inputs, and the user's acoustic inputs.

20. The system set forth in claim 8 wherein the basic information includes at least one piece of information from the group consisting of the device/user location, the user profile, previous user actions, the user's textual inputs, the user's manual inputs, and the user's acoustic inputs.

21. The system set forth in claim 9 wherein the basic information includes at least one piece of information from the group consisting of the device/user location, the user profile, previous user actions, the user's textual inputs, the user's manual inputs, and the user's acoustic inputs.

22. The system set forth in claim 10 wherein the basic information includes at least one piece of information from the group consisting of the device/user location, the user profile, previous user actions, the user's textual inputs, the user's manual inputs, and the user's acoustic inputs.

23. The system set forth in claim 11 wherein the basic information includes at least one piece of information from the group consisting of the device/user location, the user profile, previous user actions, the user's textual inputs, the user's manual inputs, and the user's acoustic inputs.

24. The system set forth in claim 12 wherein the basic information includes at least one piece of information from the group consisting of the device/user location, the user profile, previous user actions, the user's textual inputs, the user's manual inputs, and the user's acoustic inputs.

25. At least one portable device comprising:
(a) a means for acquiring at least one image that includes at least one object of interest;
(b) a means for transmitting to a remote computational facility data that includes data associated with said at least object of interest;
(c) a means for receiving processed data from said remote facility to enable (possibly with the application of additional calculations by the portable device) identification of said at least one object;
(d) a means for receiving additional information or services about said at least one object; and
(e) a means for displaying said processed data and additional information or services about said at least one object.

26. A method for identifying at least one object and providing additional information or services about at least said one object, comprising:
(a) acquiring at least one image that includes at least one object of interest;
(b) transmitting to a remote computational facility data that includes data associated with said at least object of interest;
(c) receiving processed data from said remote facility to enable identification of said at least one object;
(d) receiving additional information or services about said at least one object; and
(e) displaying said processed data and additional information or services about said at least one object.
